(19) United States
(12) Patent Application Publication
(10) Pub. No.: US 2006/0077976 A1
(43) Pub. Date: Apr. 13, 2006

(54) Apparatus and method for printing data using a server message block protocol

(75) Inventor: Hyun-wook Park, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/193,332

(22) Filed: Aug. 1, 2005

(30) Foreign Application Priority Data
Oct. 11, 2004 (KR) 2004-0081086

(51) Int. Cl. H04L 12/28

(52) U.S. Cl. 370/392; 370/401

(57) ABSTRACT

An apparatus and a method are provided for printing data through a network communication between a printer network card and a client device having a server message block (SMB) protocol for sharing a file and a printer and a transmission control protocol/internet protocol (TCP/IP) protocol to establish the network communication. The method comprises analyzing a type of data packet received from the client device, determining if the data packet can be continuously received from the client device or the receipt of the data packet should be suspended based on a result of the analysis, and requesting the TCP/IP protocol to restrict the receipt of the data packet when it is required to suspend the receipt of the data packet as a result of the determination, and transmitting a receipt restriction signal to the client device by using the TCP/IP protocol.

### CROSS-REFERENCE TO RELATED APPLICATION

This application claims the benefit under 35 U.S.C. §119(a) of Korean Patent Application, entitled “METHOD AND APPARATUS FOR PRINTING DATA USING SERVER MESSAGE BLOCK PROTOCOL”, assigned Serial No. 10-2004-0081086, filed on Oct. 11, 2004, in the Korean Intellectual Property Office, the entire disclosure of which is hereby incorporated by reference.

### BACKGROUND OF THE INVENTION

1. Field of the Invention

The present invention relates to a method of operating a network printer system. More particularly, the present invention relates to a communication apparatus and method of suspending receipt of print data when the receipt of the print data through a network should be suspended in a network printer system using a server message block (SMB) protocol.

2. Description of Related Art

Typically, a file system is required to store and manage data files to adopt a server message block (SMB) protocol. The file system is capable of creating, for example, a spooling file for a printing job or a file for file sharing.

The SMB protocol is usually used in a personal computer to personal computer (PC-to-PC) communication having such a file system, and also may be used in a system incorporating UNIX, LINUX, or an embedded operating system (OS) if such a file system is provided. An SMB protocol can be applied to a printer if it is provided with a network card.

If a print system uses a different protocol, receipt of the print data can be suspended by using a flow control. Through the flow control, a flow of print data can be controlled to retransmit print data in case of data loss during transmission/receipt of the print data or to suspend and resume transmission/receipt of the print data.

However, if a printer system uses an SMB protocol, the flow control function is not provided. Therefore, when receipt of the print data should be suspended in case of shortage of available storage capacity for storing print data or simultaneous abundant printing job requests from a plurality of client devices, an error message indicating shortage of available storage capacity for storing print data is issued. This causes problems in the printing job.

Accordingly, a need exists for an improved apparatus and method for printing data using a server message block protocol.

### SUMMARY OF THE INVENTION

The present invention provides a printing apparatus and a printing method in a networked printer system using a server message block (SMB) protocol, by which a communication method of suspending receipt of print data when the receipt of the print data through a network should be suspended can be provided, so that errors such as shortage of free storage capacity can be solved.

According to an aspect of the present invention, a method of printing data through a network communication between a printer network card and a client device having an SMB protocol for sharing a file and a printer, a network basic input/output system (NetBIOS) protocol for communication between applications and a transmission control protocol/internet protocol (TCP/IP) protocol for establishing the network communication is provided. The method comprises the steps of analyzing a type of data packet received from the client device, determining if the data packet should be continuously received from the client device or receipt of the data packet should be suspended according to a result of the analysis, and requesting the TCP/IP protocol to restrict the receipt of the data packet when it is required to suspend the receipt of the data packet as a result of the determination, and transmitting a receipt restriction signal to the client device by using the TCP/IP protocol.

The receipt restriction signal may indicate that a printer does not have available storage capacity sufficient to store the print data transmitted from the client device or that it is impossible to process the print data because the printer is currently performing another printing job.

The receipt of the data packet may be suspended when the received data packet is a packet for requesting a new printing job as a result of the analysis and a printer is currently performing another printing job.

The receipt of the data packet may be suspended when the received data packet is a packet for comprising data packets as a result of the analysis and previous print data have not been transmitted to a printer.

The receipt of the data packet may be suspended when the received data packet is a packet for requesting a new printing job and previous print data have not been transmitted to a printer while the printer is currently not processing a printing job.

According to another aspect of the present invention, an apparatus for printing data received from a client device in a network environment is provided. The apparatus comprises a printer network card, wherein the printer network card is provided with an SMB protocol for sharing a file and a printer and a TCP/IP protocol for establishing a network communication, and determines if receipt of a data packet should be suspended by analyzing a type of the data packet received from the client device, and wherein the SMB protocol requests the TCP/IP protocol to restrict the receipt of the data packet when it is required to suspend the receipt of the data packet as a result of the analysis and the TCP/IP protocol transmits a receipt restriction signal to the client device.

The receipt restriction signal may notify that a printer does not have available storage capacity sufficient to store the print data transmitted from the client device or that it is impossible to process the print data because the printer currently performs another printing job.

The receipt of the data packet may be suspended when the received data packet is a packet for requesting a new printing job as a result of the analysis and a printer is currently performing another printing job.

The receipt of the data packet may be suspended when the received data packet is a packet for comprising data packets as a result of the analysis and previous print data have not been transmitted to a printer.

The receipt of the data packet may be suspended when the received data packet is a packet for requesting a new printing job and previous print data have not been transmitted to a printer while the printer is currently not processing a printing job.

### BRIEF DESCRIPTION OF THE DRAWINGS

The above and other features and advantages of the present invention will become more apparent by describing in detail exemplary embodiments thereof with reference to the accompanying drawings in which:

FIG. 1 is a block diagram illustrating a conventional network printer system;

FIG. 2 is a block diagram illustrating a network printing job which uses a server message block (SMB) protocol based on an exemplary embodiment of the present invention;

FIG. 3 is a flow chart illustrating a method of printing data by using a SMB protocol according to an exemplary embodiment of the present invention;

FIG. 4 is a flow chart illustrating a method of determining if a print data packet can be continuously received; and

FIG. 5 is a block diagram illustrating a data printing apparatus which uses an SMB protocol according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

Hereinafter, exemplary embodiments of the present invention will be described in greater detail with reference to the accompanying drawings.

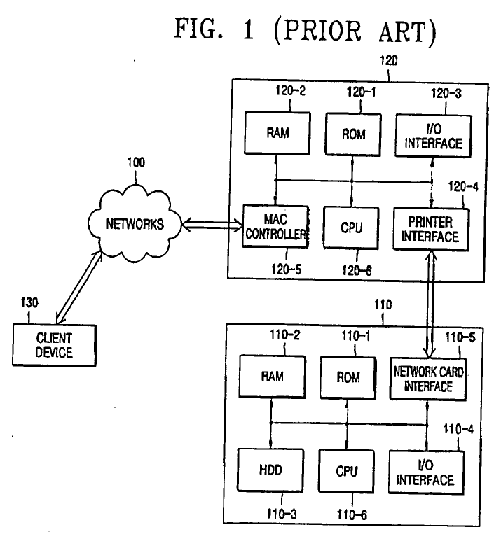

FIG. 1 is a block diagram illustrating a conventional network printer system. A network printer system comprises a network 100, a printer 110, a printer network card 120, and a client device 130. The printer network card 120 may be internally or externally incorporated into the printer 110. As an example, an external network card 120 is described herein.

The printer 110 comprises a read only memory (ROM) 110-1, a random access memory (RAM) 110-2, a hard disk drive (HDD) 110-3, an input/output (I/O) interface 110-4, a network card interface 110-5, and a central processing unit (CPU) 110-6.

The ROM 110-1 stores a program for operating a printer 110, and the RAM 110-2 and the HDD 110-3 store print data packets and internal data. The network card interface 110-5 performs a data communication with the printer network card 120, and the CPU 110-6 controls the whole operation of the printer 110.

The printer network card 120 comprises a ROM 120-1, a RAM 120-2, an I/O interface 120-3, a printer interface 120-4, a medium access control (MAC) controller 120-5, and a CPU 120-6.

The ROM 120-1 stores a program for operating the printer network card 120, and the ROM 120-2 stores print data packets. The printer interface 120-4 performs a data communication with the printer 110, and the MAC controller 120-5 transmits and receives network packets to/from the client device 130 via the network 100. The CPU 120-6 controls the whole operation of the printer 110.

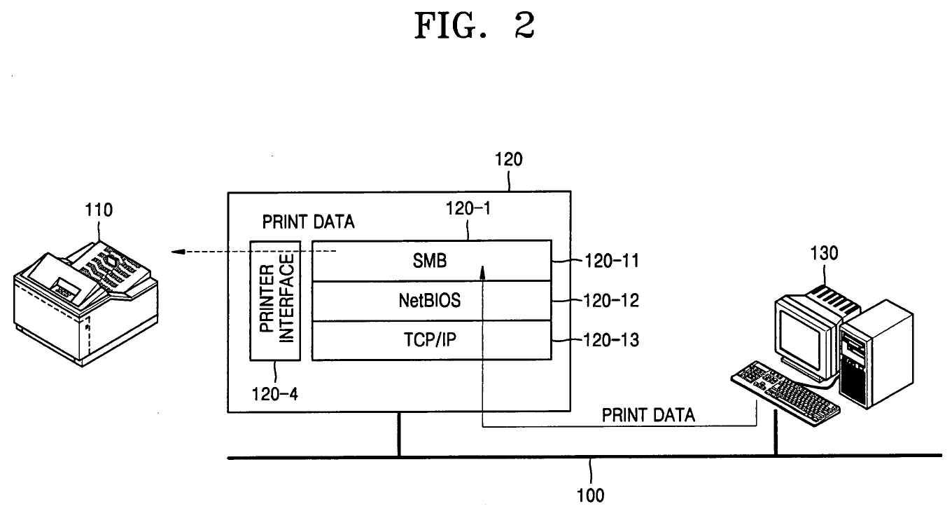

FIG. 2 illustrates a network printing job which uses a server message block (SMB) protocol. The ROM 120-1 or the RAM 120-2 in the printer network card 120 is provided with a SMB protocol 120-11, a network basic input/output (NetBIOS) protocol 120-12, and a transmission control protocol/internet protocol (TCP/IP) 120-13.

The SMB protocol 120-11 is an application protocol used for a printing job and file sharing in a network environment which uses a NetBIOS protocol or a NetBIOS extended user interface (NETBEU) protocol.

The NetBIOS protocol 120-12 allows the applications in different devices to appropriately communicate with one another in a network environment.

The TCP/IP 120-13 is a standard communication protocol in a network environment.

Referring to FIG. 2, if the client device 130 transmits print data, the printer network card 120 transmits the print data to the printer 110 by using a TCP/IP protocol 120-13, a NetBIOS protocol 120-12, and an SMB protocol 120-11.

The printer 110 which receives the print data from the client device 130 via the printer network card 120 stores the print data in a RAM 110-2 or a HDD 110-3, and then starts to print them when receipt of the entire print data is completed.

If a printing system uses different protocols, the receipt of the print data can be suspended by using a flow control. Through the flow control, a series of printing data flow can be controlled to retransmit the printing dada flow in case of data loss during transmission/receipt or to suspend and resume the transmission/receipt of the print data.

However, if a printer system uses a SMB protocol 120-11, the flow control function is not provided. Therefore, when receipt of the print data should be suspended in case of shortage of available storage capacity for storing print data or simultaneous abundant printing job requests from a plurality of client devices, an error message indicating shortage of available storage capacity is issued. This causes problems in the printing job.

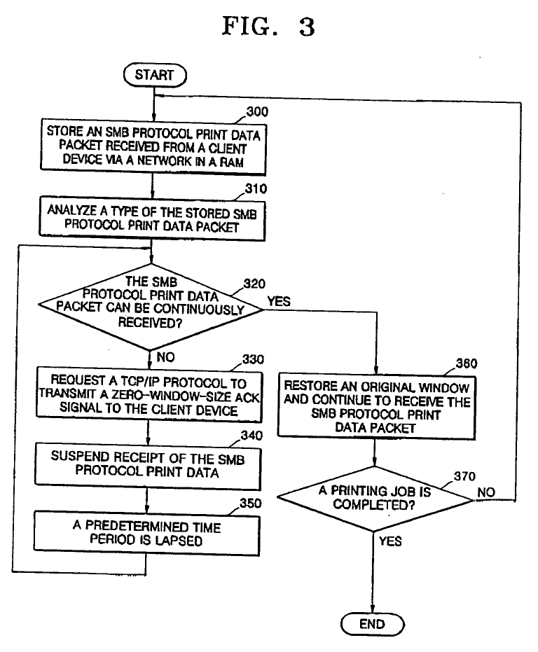

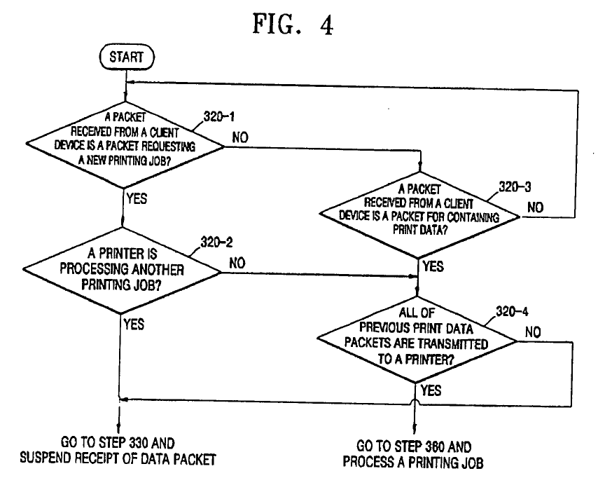

In order to solve such a problem, FIGS. 3 and 4 illustrate a data print method which uses a SMB protocol 120-11.

A user who tries to perform a printing job by using a SMB protocol 120-11 starts to transmit SMB protocol print data packets from a client device via a network 100.

Then, the printer network card 120 which receives the SMB protocol print data packets from the client device 130 via a network 100 stores the packets in the RAM 120-2 at step 300.

The CPU 120-6 of the printer network card 120 analyzes the SMB protocol print data packet stored in the RAM 120-2 to identify a packet type at step 310.

According to the SMB protocol, various packets are defined. For example, a packet for a printing job, a packet for storing print data, a packet for indicating initiation of a print job, or a packet for including print data may be defined. The CPU 120-6 analyzes the SMB protocol print data stored in the RAM 120-2 to identify its packet type.

Also, the CPU 120-6 determines if the SMB protocol print data packets can be continuously received as a result of analysis at step 320.

FIG. 4 illustrates a method of determining if the SMB protocol print data packets can be continuously received.

First, the CPU 120-6 determines if the data packet stored in the RAM 120-2, that is, the SMB protocol print data packet received from the client device 130, is a packet for requesting a printing job at step 320-1.

If the received SMB protocol print data packet is a packet for requesting a printing job, the CPU 120-6 examines if the printer 110 currently performs other printing jobs. If the CPU 120-6 determines that the printer 110 currently performs other printing jobs, the process proceeds to step 330 in order to suspend receipt of the SMB protocol print data packets from the client device 130 at step 320-2.

Meanwhile, if the received SMB protocol print data packet is not the packet for requesting a print job, the CPI 120-6 determines if the SMB protocol print data packet received from the client device 130 is a packet for containing print data at step 320-3.

If the received SMB protocol print data packet is a packet for containing print data, the CPU 120-6 determines if all the previous print data are already transmitted to the printer 130. If all of the previous print data are not transmitted to the printer 130, the process proceeds to step 330 in order to suspend receipt of the SMB protocol print data packet. If all of the previous print data are already transmitted to the printer 130, the receipt of the SMB protocol print data packets is continued or the process proceeds to step 360 in order to complete the printing job at step 320-4.

Returning to FIG. 3, if a result of analysis of the packet at step 320 shows that the SMB protocol print data packets can not be continuously received, for example, if the received SMB protocol print data packet is a packet for requesting a printing job while the printer 110 performs other printing jobs, or if all of the previous print data have not been transmitted to the printer 110 while the received SMB protocol print data packet is a packet for containing print data, the SMB protocol 120-11 requests the TCP/IP 120-13 to transmit a zero-window-size acknowledge signal to the client device 130 at step 330.

Since the SMB protocol 120-11 is not provided with a function of restricting receipt of the data, a lower level protocol, for example, the TCP/IP 120-13 is used to restrict the receipt of the data. The TCP/IP 120-13 transmits an acknowledgement signal for the received packet when a SMB protocol print data packet is received from the client device 130.

When the TCP/IP 120-13 transmits the acknowledgement signal, it also transmits information on available storage capacity to allow receiving more SMB protocol print data packets together. In this case, the available storage capacity is indicated as a window size.

In order to restrict receipt of the SMB protocol print data packets, the SMB protocol 120-11 requests the TCP/IP 120-13 to send an acknowledgement signal having a size of zero.

In response to the request from the SMB protocol 120-11, the TCP/IP 120-13 transmits a zero-window-size acknowledgement signal to the client device 130. The client device 130 which receives this acknowledgement signal determines that the printer network card 120 does not have available storage capacity sufficient to receive more SMB print data packets, and prohibits its transmission of the SMB protocol print data packets to allow the printer network card 120 to suspend receipt of the SMB protocol print data packets at step 340.

After the printer network card 120 suspends receipt of the SMB protocol print data packets for a predetermined time period at step 350, the process returns to step 320 to determine if it is possible to continue to receive the SMB protocol print data packets.

Meanwhile, if the result of analyzing the packet at step 320 shows that it is possible to receive the SMB protocol print data packets, for example, if the printer 110 does not perform other printing jobs while the received SMB protocol print data packet is a packet requesting a printing job, or if all of the previous print data have been transmitted to the printer 110 while the receive SMB protocol print data packet is a packet for containing print data, the TCP/IP 120-13 restores the original window size, transmits an acknowledgement signal to the client device 130, and then continues to receive the SMB protocol print data packets from the client device 130 at step 360.

When the SMB protocol print data packets are received, a corresponding printing job is processed and then the process ends at step 370.

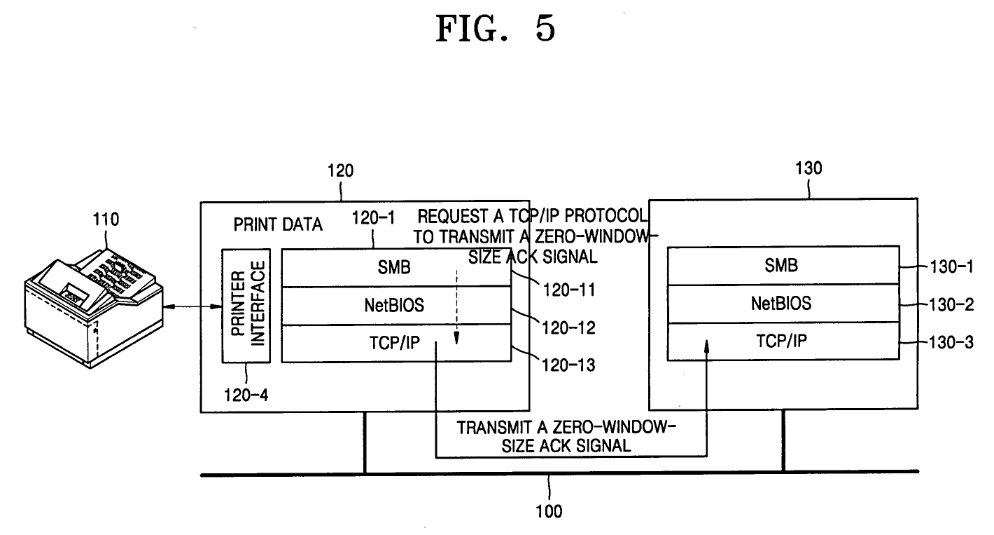

FIG. 5 illustrates a data printing apparatus which uses an SMB protocol according to an exemplary embodiment of the present invention. When the result of analyzing the SMB protocol print data packet in a printer network card 120 shows that it is not possible to receive the SMB protocol print data packets, the SMB protocol request a TCP/IP 120-13 to send a zero-window-size acknowledgment signal to a client device 130.

In response to the request of SMB protocol 120-11, the TCP/IP 120-13 transmits the zero-window-size acknowledgement signal to the TCP/IP 130-3 of the client device 130.

The client device which receives this signal determines that the printer network card 120 does not have available storage capacity sufficient to receive more SMB protocol print data packets and then prohibits its transmission of SMB protocol print data packets. Therefore, the printer network card 120 can suspend receipt of the SMB protocol print data packets.

According to the exemplary embodiments of the present invention, it is possible to suspend receipt of the print data by using a SMB protocol when it is required to suspend receipt of the print data. Therefore, it is possible to solve shortage of available storage capacity and thus appropriately perform a printing job.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of printing data through a network communication between a printer network card and a client device having a server message block (SMB) protocol for sharing a file and a printer and a transmission control protocol/internet protocol (TCP/IP) protocol to establish the network communication, the method comprising:
analyzing a type of data packet received from the client device;
determining if the data packet should be continuously received from the client device or receipt of the data packet should be suspended according to a result of the analysis; and
requesting the TCP/IP protocol to restrict the receipt of the data packet when it is required to suspend the receipt of the data packet as a result of the determination, and transmitting a receipt restriction signal to the client device by using the TCP/IP protocol.

2. The method according to claim 1, wherein the receipt restriction signal determines that a printer does not have available storage capacity sufficient to store the print data transmitted from the client device or that it is not possible to process the print data because the printer is currently performing another printing job.

3. The method according to claim 1, wherein the receipt of the data packet is suspended when the received data packet is a packet for requesting a new printing job as a result of the analysis and a printer is currently performing another printing job.

4. The method according to claim 1, wherein the receipt of the data packet is suspended when the received data packet is a packet for containing print data packets as a result of the analysis and previous print data have not been transmitted to a printer.

5. The method according to claim 1, wherein the receipt of the data packet is suspended when the received data packet is a packet for requesting a new printing job and previous print data have not been transmitted to a printer while the printer is currently not processing a printing job.

6. An apparatus for printing data received from a client device in a network environment, the apparatus comprising:
a printer network card,
wherein the printer network card is provided with a server message block (SMB) protocol for sharing a file and a printer and a transmission control protocol/internet protocol (TCP/IP) protocol to establish a network communication, and determines if receipt of a data packet should be suspended by analyzing a type of the data packet received from the client device; and
wherein the SMB protocol requests the TCP/IP protocol to restrict the receipt of the data packet when it is required to suspend the receipt of the data packet as a result of the analysis and the TCP/IP protocol transmits a receipt restriction signal to the client device.

7. The apparatus according to claim 6, wherein the receipt restriction signal determines that a printer does not have available storage capacity sufficient to store the print data transmitted from the client device or that it is not possible to process the print data because the printer currently performs another printing job.

8. The apparatus according to claim 6, wherein the receipt of the data packet is suspended when the received data packet is a packet for requesting a new printing job as a result of the analysis and a printer is currently performing another printing job.

9. The apparatus according to claim 6, wherein the receipt of the data packet is suspended when the received data packet is a packet for containing print data packets as a result of the analysis and previous print data have not been transmitted to a printer.

10. The apparatus according to claim 6, wherein the receipt of the data packet is suspended when the received data packet is a packet for requesting a new printing job and previous print data have not been transmitted to a printer while the printer is currently not processing a printing job.
